(19) United States
(12) Patent Application Publication
(10) Pub. No.: US 2009/0050667 A1
(43) Pub. Date: Feb. 26, 2009

(54) NAIL MAGAZINE

(75) Inventor: Chien-Kuo Po, Taichung (TW)

Correspondence Address: DARBY & DARBY P.C., P.O. BOX 770, Church Street Station, New York, NY, 10008-0770, US

(73) Assignee: BASSO INDUSTRY CORP., Taichung (TW)

(21) Appl. No.: 11/951,905

(22) Filed: Dec. 6, 2007

(30) Foreign Application Priority Data
Aug. 23, 2007 (TW) 096131220

(51) Int. Cl. B27F 7/02; B27F 7/00; B27F 7/05

(52) U.S. Cl. 227/120; 227/127; 227/132

(57) ABSTRACT

A nail magazine includes: a magazine body defining a nail channel extending in a longitudinal direction, a rear opening for access into the nail channel, and a side opening for access into the nail channel; a cover mounted on and slidable relative to the magazine body and formed with an inner recess in spatial communication with the nail channel through the side opening; and a nail-driving unit including a slider mounted on the cover and slidable relative to the cover in the longitudinal direction, and a nail-pushing element mounted on the slider and movable relative to the slider in a transverse direction relative to the longitudinal direction.

### CROSS-REFERENCE TO RELATED APPLICATION

This application claims priority of Taiwanese application no. 096131220, filed on Aug. 23, 2007.

### BACKGROUND OF THE INVENTION

1. Field of the Invention

The invention relates to a nail magazine, more particularly to a nail magazine including a magazine body and a nail-pushing element movable in a transverse direction relative to the length of the magazine body.

2. Description of the Related Art

As shown in FIG. 1, a conventional nail magazine 1 for a nail gun has a magazine body 11, a cover 12 and a nail-driving unit 13. The magazine body 11 has a lateral side formed with a nail channel 111. The cover 12 is mounted slidably on the magazine body 11 and is slidable relative to the magazine body 11 in a longitudinal direction for covering and uncovering the nail channel 111 so as to permit loading of nails 2 into the nail channel 111. The nail-driving unit 13 includes a nail-pushing element 131 disposed in the nail channel 111 and slidable together with the cover 12.

However, when the space that the nail gun is to be used is relatively short in length, it is relatively inconvenient to uncover the nail channel 111 for loading of the nails 2.

### SUMMARY OF THE INVENTION

Therefore, the object of the present invention is to provide a nail magazine that can overcome the aforesaid drawback associated with the prior art.

Accordingly, a nail magazine of the present invention comprises: a magazine body having front and rear open ends and two opposite sides, and defining a nail channel extending in a longitudinal direction from the front open end to the rear open end, a rear opening for access into the nail channel from the rear open end, and a side opening at one of the sides for access into the nail channel from said one of the sides; a cover mounted slidably on said one of the sides of the magazine body and slidable relative to the magazine body in the longitudinal direction between closed and opened positions for covering and uncovering the side opening, and formed with an inner recess in spatial communication with the nail channel through the side opening; and a nail-driving unit including a slider mounted slidably on the cover and slidable relative to the cover in the longitudinal direction between first and second positions, and a nail-pushing element mounted movably on the slider and movable relative to the slider in a transverse direction relative to the longitudinal direction between retracted and extended positions. The nail-pushing element is disposed in the nail channel and is offset from the inner recess in the transverse direction when the slider is disposed at the first position and when the nail-pushing element is disposed at the extended position. The nail-pushing element is disposed within the nail channel and is aligned with the inner recess in the transverse direction when the slider is disposed at the second position and when the nail-pushing element is disposed at the extended position. The nail-pushing element is disposed within the inner recess when the slider is disposed at the second position and when the nail-pushing element is disposed at the retracted position.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a conventional nail magazine;

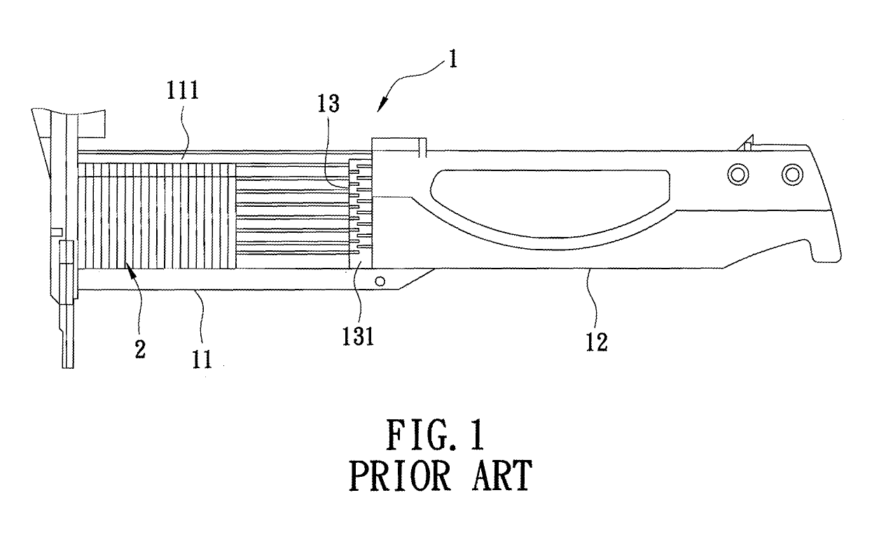

FIG. 2 is a perspective view of the preferred embodiment of a nail magazine according to the present invention;

FIG. 3 is a sectional view taken along line III-III in FIG. 2;

FIG. 4 is a perspective view of a cover of the preferred embodiment;

FIG. 5 is an assembled perspective view of the preferred embodiment illustrating a state where a slider is disposed at a second position and where a nail-pushing element is disposed at a retracted position;

FIG. 6 is a sectional view taken along line VI-VI in FIG. 5; and

FIG. 7 is a perspective view of the preferred embodiment illustrating how nails can be loaded via a rear opening when the nail-pushing element is disposed at the retracted position.

### DETAILED DESCRIPTION OF THE PREFERRED EMBODIMENT

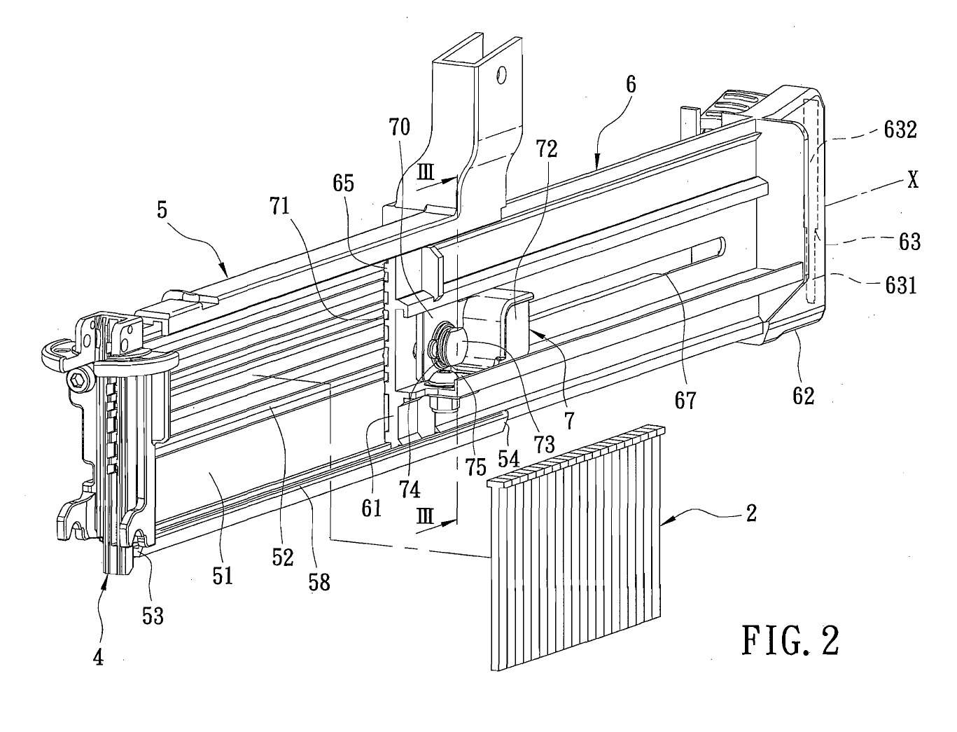

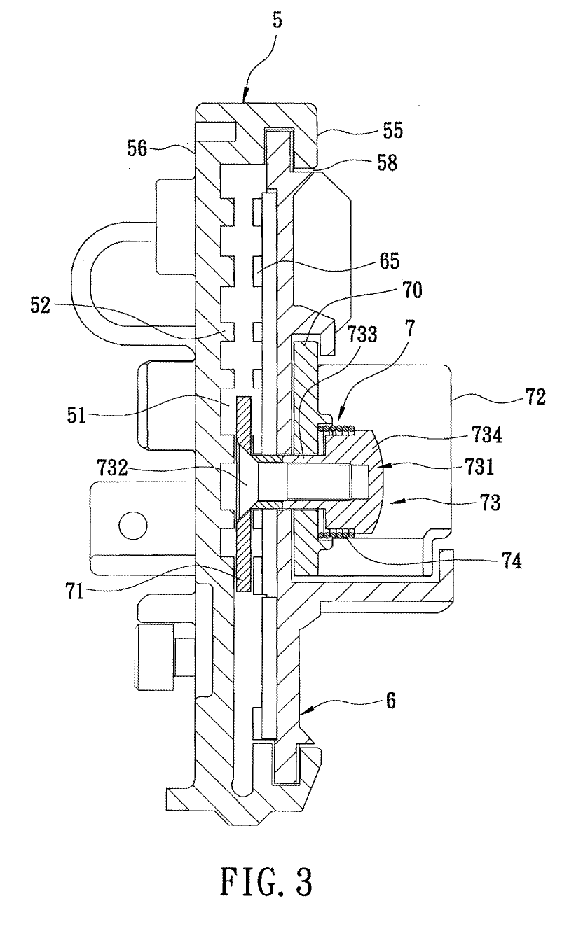

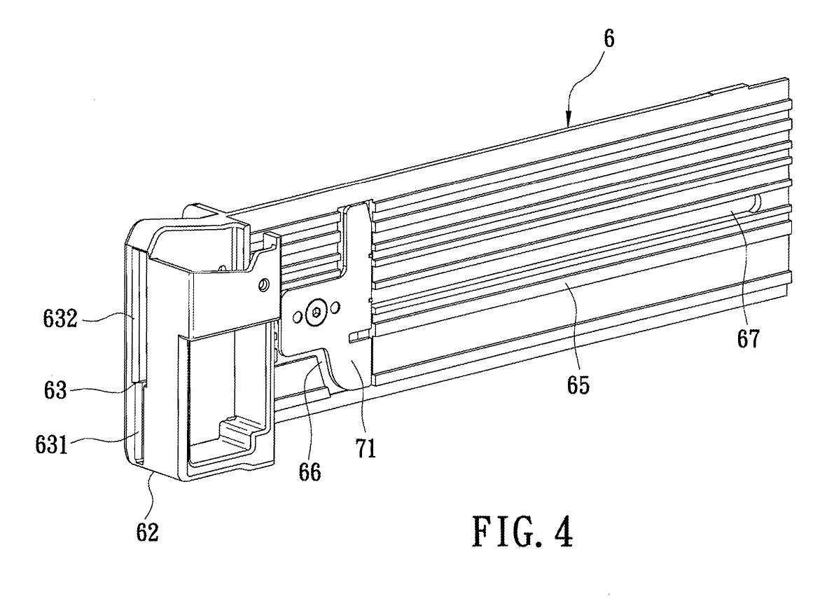

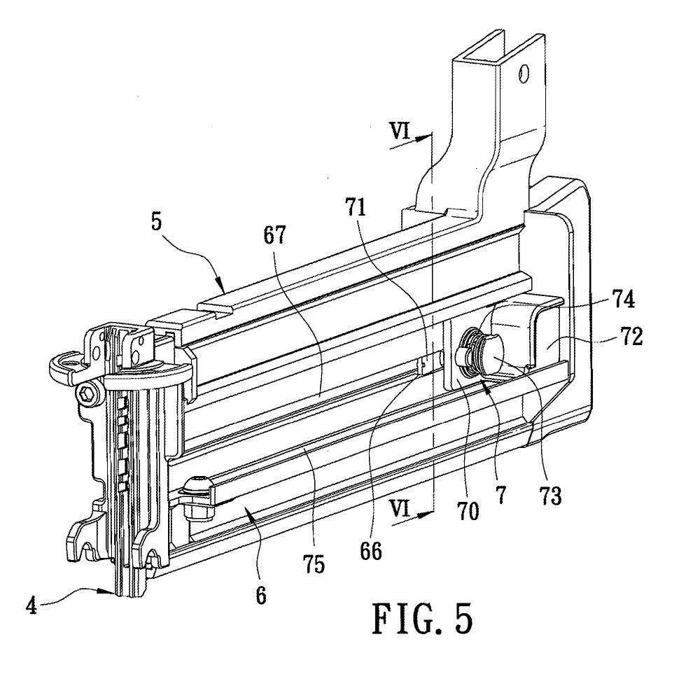

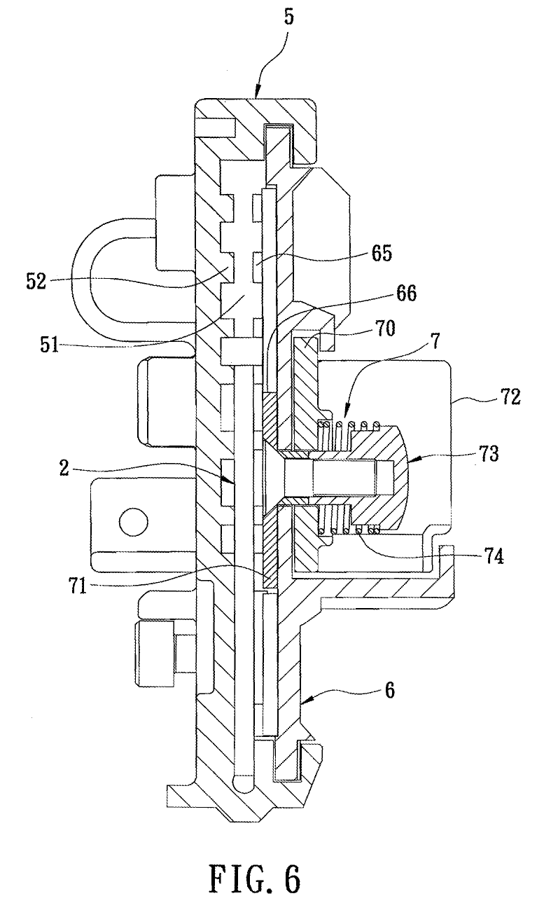

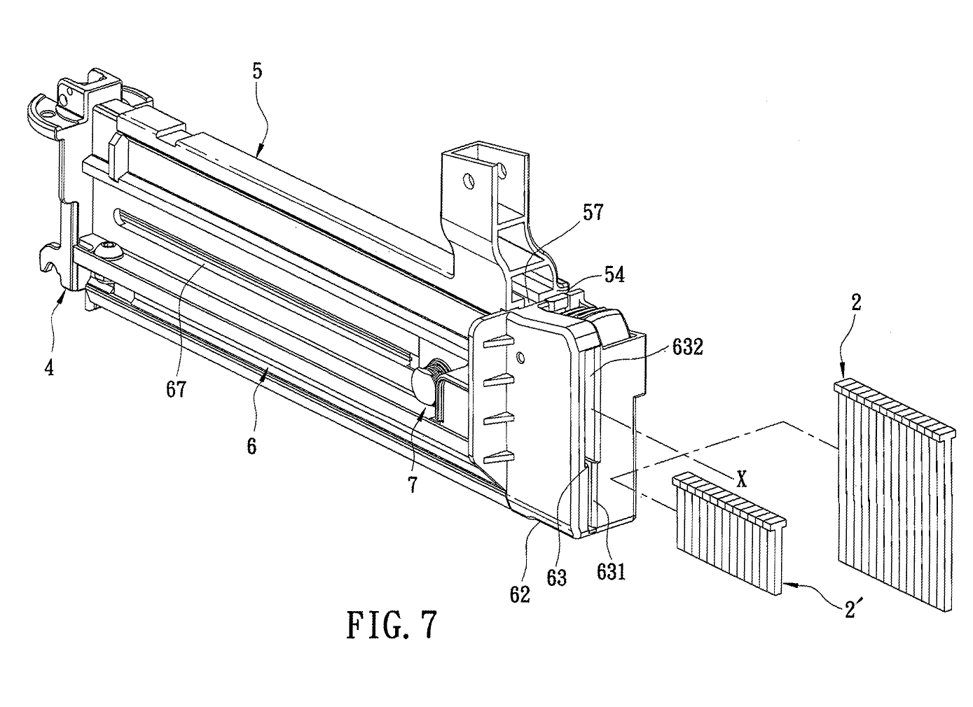

Referring to FIGS. 2 to 4, the preferred embodiment of a nail magazine according to the present invention is shown to include: a magazine body 5 having front and rear open ends 53, 54 and two opposite sides 55, 56, and defining a nail channel 51 extending in a longitudinal direction (X) from the front open end 53 to the rear open end 54, a rear opening 57 (see FIG. 7) for access into the nail channel 51 from the rear open end 54, and a side opening 58 at one of the sides 56 for access into the nail channel 51 from said one of the sides 56; a cover 6 mounted slidably on said one of the sides 56 of the magazine body 5 and slidable relative to the magazine body 5 in the longitudinal direction (X) between closed and opened positions (see FIGS. 5 and 2) for covering and uncovering the side opening 58, and formed with an inner recess 66 (see FIGS. 4 and 6) in spatial communication with the nail channel 51 through the side opening 58; a nail-driving unit 7 including a slider 70 mounted slidably on the cover 6 and slidable relative to the cover 6 in the longitudinal direction (X) between first and second positions (see FIGS. 2 and 5), and a nail-pushing element 71 mounted movably on the slider 70 and movable relative to the slider 70 in a transverse direction relative to the longitudinal direction (X) between retracted and extended positions (see FIGS. 6 and 3). The nail-pushing element 71 is disposed in the nail channel 51 and is offset from the inner recess 66 in the transverse direction when the slider 70 is disposed at the first position and when the nail-pushing element 71 is disposed at the extended position, as best shown in FIG. 3. The nail-pushing element 71 is disposed within the nail channel 51 and is aligned with the inner recess 66 in the transverse direction when the slider 70 is disposed at the second position and when the nail-pushing element 71 is disposed at the extended position, as best shown in FIGS. 5 and 6. The nail-pushing element 71 is disposed within the inner recess 66 when the slider 70 is disposed at the second position and when the nail-pushing element 71 is disposed at the retracted position, as best shown in FIG. 7.

In this embodiment, the cover 6 is formed with an elongate slot 67 extending in the longitudinal direction (X) between the front and rear open ends 53, 54 of the magazine body 5. The nail-driving unit 7 further includes a movable linkage 73 extending through the elongate slot 67 to interconnect the nail-pushing element 71 and the slider 70.

Referring again to FIGS. 2 and 3, the movable linkage 73 includes a pressable button 731, a fastener 732, and an urging member 74. The pressable button 731 has a shank 733 extending through the slider 70 and connected to the nail-pushing element 71 through the fastener 732, and a stepped head 734 enlarged in cross-section from the shank 733. The urging member 74 is sleeved around a portion of the stepped head 734 and abuts against the stepped head 734 and the slider 70 so as to urge the nail-pushing element 71 to move in a direction toward the slider 70.

The nail-driving unit 7 further includes a spring housing 72 mounted on the slider 70, and a spiral spring 75 mounted securely in the housing 72 and having one end fixed to a front end 61 of the cover 6 so as to urge the slider 70 together with the nail-pushing element 71 to move in a direction toward the front open end 53 of the magazine body 5.

Referring again back to FIGS. 2 and 7, the cover 6 includes a rear end cap 62 formed with a rear slot 63 aligned with the rear opening 57 of the magazine body 5. The rear slot 63 has an upper section 632 and a lower section 631 that is reduced in width from the upper section 632 so as to permit loading of different sizes nails 2, 2′ into the nail channel 51 of the magazine body 5.

The nail magazine further includes a nail ejection seat 4 mounted on the front end 53 of the magazine body 5. The magazine body 5 and the cover 6 are respectively formed with inner ribs 52, 65 (see FIGS. 2, 3 and 7) extending in the longitudinal direction (X) for positioning the nails 2, 2′ in the nail channel 51.

In use, referring to FIGS. 2 and 3, when the nails 2 are to be loaded via the side opening 58 of the magazine body 5, the cover 6 is moved to the opened position (see FIG. 2), the nails 2 are subsequently and directly placed into the nail channel 51 through the side opening 58, and the cover 6 is then moved to the closed position.

Referring to FIGS. 5 to 7, when the nails 2 are to be loaded via the rear opening 57 of the magazine body 5 due to an insufficient space for moving the cover 6 to the opened position, the slider 70 is first moved to the second position to allow the nail-pushing element 71 to move to the retracted position by the urging action of the urging member 74, the nails 2, 2′ are subsequently loaded into the nail channel 51 through the rear opening 57, and the pressable button 731 is then pressed to allow the nail-pushing element 71 to move in the nail channel 51 to abut against the nails 2, 2′ by the urging action of the spiral spring 75.

With the inclusion of the slider 70 and the nail-driving unit 7 in the nail magazine of this invention, the aforesaid drawback associated with the prior art can be eliminated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A nail magazine comprising:
a magazine body having front and rear open ends and two opposite sides, and defining a nail channel extending in a longitudinal direction from said front open end to said rear open end, a rear opening for access into said nail channel from said rear open end, and a side opening at one of said sides for access into said nail channel from said one of said sides;
a cover mounted slidably on said one of said sides of said magazine body and slidable relative to said magazine body in the longitudinal direction between closed and opened positions for covering and uncovering said side opening, and formed with an inner recess in spatial communication with said nail channel through said side opening; and
a nail-driving unit including a slider mounted slidably on said cover and slidable relative to said cover in the longitudinal direction between first and second positions, and a nail-pushing element mounted movably on said slider and movable relative to said slider in a transverse direction relative to the longitudinal direction between retracted and extended positions;
wherein said nail-pushing element is disposed in said nail channel and is offset from said inner recess in the transverse direction when said slider is disposed at the first position and when said nail-pushing element is disposed at the extended position;
wherein said nail-pushing element is disposed within said nail channel and is aligned with said inner recess in the transverse direction when said slider is disposed at the second position and when said nail-pushing element is disposed at the extended position; and
wherein said nail-pushing element is disposed within said inner recess when said slider is disposed at the second position and when said nail-pushing element is disposed at the retracted position.

2. The nail magazine as claimed in claim 1, wherein said cover is formed with an elongate slot extending in the longitudinal direction between said front and rear open ends of said magazine body, said nail-driving unit further including a movable linkage extending through said elongate slot to interconnect said nail-pushing element and said slider.

3. The nail magazine as claimed in claim 2, wherein said movable linkage includes a pressable button, a fastener, and an urging member, said pressable button having a shank connected to said nail-pushing element through said fastener, and a stepped head enlarged in cross-section from said shank, said urging member being sleeved around a portion of said stepped head and abutting against said stepped head and said slider so as to urge said nail-pushing element to move in a direction toward said slider.

4. The nail magazine as claimed in claim 1, wherein said nail-driving unit further includes a spring housing mounted on said slider, and a spiral spring mounted securely in said spring housing and having one end fixed to one end of said cover so as to urge said slider together with said nail-pushing element to move in a direction toward said front open end of said magazine body.

5. The nail magazine as claimed in claim 1, wherein said cover includes a rear end cap formed with a rear slot aligned with said rear opening of said magazine body, said rear slot having an upper section and a lower section that is reduced in width from said upper section.
